(19) United States
(12) Patent Application Publication
(10) Pub. No.: US 2013/0282245 A1
(43) Pub. Date: Oct. 24, 2013

(54) Method for Controlling an Automatic Transmission

(71) Applicants: Bernd Dietzel, Syrgenstein (DE); Rolf Hoffmann, Steinheim (DE)

(72) Inventors: Bernd Dietzel, Syrgenstein (DE); Rolf Hoffmann, Steinheim (DE)

(21) Appl. No.: 13/884,406

(22) PCT Filed: Jun. 14, 2012
(86) PCT No.: PCT/EP2012/002504

§ 371 Date: Jul. 11, 2013

(30) Foreign Application Priority Data
Sep. 28, 2011 (DE) 10 2011 114 440.8

(51) Int. Cl. B60W 10/11; B60W 10/06

(52) U.S. Cl. CPC B60W 10/11; B60W 10/06
USPC 701/60; 477/115

(57) ABSTRACT

The invention relates to a method for controlling an automatic transmission, more particularly a method for controlling gear changes in an automatic transmission of a motor vehicle driven by an internal combustion engine, having the following steps: predicting the fuel consumption of the internal combustion engine that would result if the automatic transmission were shifted from its present gear into a next higher gear with relatively low transmission ratio between a transmission input and a transmission output of the automatic transmission, and/or predicting the fuel consumption of the internal combustion engine that would result if the automatic transmission were shifted from its present gear into a next lower gear with a relatively high transmission ratio between the transmission input and the transmission output; and comparing the predicted fuel consumption of the internal combustion engine in the next higher gear of the automatic transmission and/or the predicted fuel consumption of the internal combustion engine in the next lower gear of the automatic transmission with the present fuel consumption of the internal combustion engine; shifting the automatic transmission into the next higher gear or into the next lower gear as a function of the comparison in order to obtain a fuel consumption saving. The invention is characterized in that, before the shift, an additional fuel consumption resulting from the shift process itself is predicted, and a shift is performed as a function of the predicted additional fuel consumption.

The present invention relates to a method for controlling the gear shifting in an automatic transmission of a motor vehicle driven by an internal combustion engine, in detail according to the preamble of claim 1.

Automatic transmissions do currently shift gears not only depending on the speed of the internal combustion engine that drives the transmission or depending on the speed of the output shaft of the transmission, proportional to the current speed of the motor vehicle from a current gear, which is also known as the starting gear, to a next higher gear or a next lower gear, which is also known as the target gear, but further quantities of the drive train or the ambient parameters are taken into account for increasing comfort and especially for reducing fuel consumption of the internal combustion engine, depending on which it is decided whether or not the shifting of the gear is to be carried out. For example, the published application DE 10 2006 009 589 A1, which shall be regarded as the closest prior art, describes a selection of the most favorable gear from various possible gears, with only such gear being selected which is capable of supplying the desired drive power in combination with the lowest fuel consumption by taking into account a transmission-efficiency characteristic map which determines the transmission efficiencies for each of the gears to be considered.

The published application DE 197 03 561 A1 describes a device for evaluating vehicle, drive and operating parameters of a vehicle in order to select and set a transmission ratio of a transmission according to predetermined calculating rules, characteristic values or characteristic maps by means of a microprocessor, with an acceleration of the vehicle being determined by calculation from a speed of a drive train corresponding to the travelling speed. A uniform device is created for different types of transmissions, which requires only a few parameters to be adjusted to the vehicle for the selection of a transmission ratio and the shifting.

The European patent specification EP 1 047 889 B1 proposes the omission of conventional shift point determination and the replacement by real-time prediction of the subsequent speeds to be achieved in the target gear, The conventional data records in conventional shifting programs for load-step, acceleration and speed-dependent shifting speeds are replaced by the characteristic map of the internal combustion engine, especially in form of a power/speed diagram or torque/speed diagram. Shifting occurs for enabling fuel-saving driving behavior in combination with sufficient driving power, especially by taking into account the characteristic map of the specific fuel consumption.

DE 600 07 858 T2 proposes calculating the gear shifting times of an automatic transmission for different gears and to include them in the calculation of the specific fuel consumption.

Although therefore various shifting strategies are known for achieving the lowest possible fuel consumption of a motor vehicle, the fuel consumption of vehicles and the resulting CO₂ emissions are increasingly in the focus of developments, and there is a need for new shifting strategies which enable a further reduction in fuel consumption of the internal combustion engine. Methods for controlling the shifting of gears in an automatic transmission shall occur for realizing new shifting strategies without any additional components if possible and especially by using quantities in the motor vehicle which (if possible) are available anyway in a transmission control device which controls such gear shifting in an automatic transmission, or which can be made available to the transmission control device with little additional effort.

The present invention is therefore based on the object of providing a method for controlling the gear shifting in an automatic transmission of a motor vehicle driven by an internal combustion engine, with which the average fuel consumption of the motor vehicle or the internal combustion engine which drives the motor vehicle can be reduced further. The method shall be applicable especially to vehicles which are driven exclusively by an internal combustion engine and also in so-called hybrid vehicles in which one or several electric motors can also be used for driving the vehicle in addition to an internal combustion engine.

The object in accordance with the invention is achieved by a method with the features of claim 1. The dependent claims provide appropriate and especially advantageous embodiments of the method in accordance with the invention. A transmission control device is further provided which is set up to perform a method in accordance with the invention, wherein the transmission control device, as defined, comprises the usual components such as connections to actuators in the transmission in order to actuate them and programmable memory components in which a program is stored which depending on signals to the inputs of the control device generates the various control signals for the actuators.

The method in accordance with the invention for controlling the gear shifting in an automatic transmission of a motor vehicle driven by an internal combustion engine comprises the following steps:
predicting the fuel consumption of the internal combustion engine that would result if the automatic transmission were shifted from its present gear into a next higher gear with relatively lower transmission ratio between a transmission input and a transmission output of the automatic transmission, and/or predicting the fuel consumption of the internal combustion engine that would result if the automatic transmission were shifted from its present gear into a next lower gear with a relatively higher transmission ratio between the transmission input and the transmission output, and
comparing the predicted fuel consumption of the internal combustion engine in the next higher gear of the automatic transmission and/or the predicted fuel consumption of the internal combustion engine in the next lower gear of the automatic transmission with the present fuel consumption of the internal combustion engine;
shifting the automatic transmission into the next higher gear or into the next lower gear depending on the comparison in order to obtain a reduction in fuel consumption.

In accordance with the invention, an additional fuel consumption resulting from the shifting process itself will be predicted before the shifting, and shifting is performed depending on said predicted additional fuel consumption.

The transmission ratio between the transmission input and the transmission output can be represented by the ratio of the speeds, i.e. the speed of the transmission output divided by the speed of the transmission input. A transmission ratio that is clearly larger than 1 will usually be present in the lower gears, with a respective torque multiplication from the transmission input to the transmission output, and in the higher and/or highest gear a transmission ratio of 1 or slightly larger or slightly lower than 1 can be present.

The additional fuel consumption can be determined for example on the basis of predetermined, currently detected or calculated boundary conditions prior to shifting, or a data record will be predetermined which comprises for each shifting an estimated value for the additional fuel consumption which is caused by the shifting itself. Such a data record can be stored in the transmission control device for example. The stored estimated values in the data record can be determined according to an embodiment in accordance with the invention prior to the delivery of the vehicle by the operation of said vehicle or by operation of the transmission and can be stored in the data record, and/or the estimated values can be learned and/or adapted during the operation of the vehicle in that the actual additional fuel consumption will be detected during a respective shifting process.

It is especially advantageous if an energetic amortization period is calculated from the predicted fuel consumption and the predicted additional fuel consumption by the shifting process itself, within which the predicted additional fuel consumption by shifting process itself would be saved during travel with the vehicle in the gear of the automatic transmission for which the fuel consumption was predicted. Shifting can then occur depending on said calculated energetic amortization period, e.g. only when the energetic amortization period lies beneath a predetermined limit value. The limit value can be predetermined absolutely or variably depending on specific current or predicted boundary conditions present after the shifting process.

According to an embodiment of the invention it is detected in operation of the motor vehicle how often the automatic transmission has shifted back to the gear prior to shifting within a predetermined interval and within a predetermined distance recently travelled with the motor vehicle or within a predetermined time interval that has just expired (i.e. within the most recent time interval) after the shifting of the automatic transmission into the next higher or lower gear. An average shift-down frequency can be determined therefrom. Such a shift-down frequency within the expired time interval or the recently travelled distance can be stored and the shifting can occur depending on said average shift-down frequency in the most recent period of time or the recently travelled distance. In particular, such an average shift-down frequency will be determined and advantageously stored for various different individual gears, advantageously for each individual gear with the exception of the highest gear and/or the lowest gear (it is no longer possible to shift down in the lowest gear, so that there is no shift-down frequency for shifting down, and for the highest gear there is accordingly no shift-down frequency for shifting up).

Alternatively, the average shift-down period can be determined instead of the average shift-down frequency, which means the time interval after which the automatic transmission was shifted back to the gear before the shifting after having shifted into a next higher gear or into a next lower gear. Both the average shift-down frequency and also the average shift-down period describe a probability with which downshifting occurs again to the initial gear with higher fuel consumption after shifting into a supposedly fuel-saving gear as a result of existing unfavorable boundary conditions, e.g. when travelling up an ascending gradient. Such downshifting itself produces additional fuel consumption, so that the consideration of the probability of downshifting from empirical values is advantageous, namely the determined average shift-down time or the determined average shift-down frequency in the decision whether shifting is to be performed. For example, the additional fuel consumption for shifting down can be predicted and can be weighted with the average shift-down frequency or the average shift-down time, and the shifting can occur depending on the weighted additional fuel consumption for shifting down. As a result, the transmission control device would automatically move the shift points upwardly in hilly areas, whereas it would also automatically shift them again to lower speeds when used in flat terrain.

In accordance with an embodiment of the method in accordance with the invention, shifting occurs depending on one or several of the following quantities which are predicted at least for the state after the shifting and are detected or calculated also for the current state, i.e. prior to shifting, in comparison with the predicted quantities:
Ascending gradient on which the motor vehicle moves
Vehicle acceleration at current position of driving pedal
Vehicle acceleration under full throttle
Engine speed
Vehicle speed
Subsequent speeds of shifting elements in the automatic transmission
Time limitation of occurring speed ranges

The individual quantities can be converted into additional fuel consumption, especially by multiplication with a conversion factor predetermined for each quantity, and shifting can then occur depending on this additional fuel consumption.

If for example an estimated value is known or detected for the ascending gradient on which the vehicle travels, the vehicle acceleration can be predicted in current driving pedal position and also under full throttle for each of the examined gears, especially for the next higher gear, the next lower gear and the current gear. If a conversion factor is also determined for the acceleration in order to obtain additional pertinent fuel consumption, this factor allows making a direct setting as to how much additional fuel consumption an improved acceleration is worth. Similarly, a minimum acceleration can be determined which needs to be reached in the next gear so that shifting is permitted to this gear.

If reference is made in the specifications to the next higher gear or the next lower gear, then this shall comprise in accordance with an embodiment according to the invention the physical gear to be engaged in the automatic transmission which comprises the next lower transmission ratio or the next higher transmission ratio in comparison with the current transmission ratio of the current gear. If the automatic transmission permits overlap shifting over several gears, the next higher gear or the next lower gear can also mean a target gear of such an overlap shifting.

It is advantageous if the automatic transmission is associated with a transmission control device which carries out a method in accordance with the invention. The transmission control device can read at least one quantity for example which correlates to the output speed and a quantity correlating to an operating speed of the internal combustion engine, and can output a transmission ratio signal on the basis of at least one of these quantities for setting a transmission ratio of the automatic transmission. The input speed of the transmission or a quantity correlating to said input speed can be read into the transmission control device instead of or in addition to the output speed of the automatic transmission.

The transmission control device is additionally provided with data of fuel consumption and especially of the engine torque according to an advantageous embodiment. For example, the transmission control device can determine a characteristic consumption map of the internal combustion engine during the operating time of the motor vehicle and also during operation prior to delivery of the motor vehicle. Alternatively, this characteristic consumption map could also be predetermined in a data record of the transmission control device or any other control device, especially the control device of the internal combustion engine. According to a further embodiment, such a characteristic consumption map can consider not only the internal combustion engine (especially the diesel engine) or its parameters, but also parameters of the electrical machine and/or secondary loads (e.g. in a parallel hybrid or a serial hybrid), especially with its efficiencies, and advantageously also in dragging and braking operation, The transmission control device can now determine for the next lower gear and the next higher gear from the characteristic consumption map the level of fuel consumption in these gears, which can be designated herein as the predicted fuel consumption of the internal combustion engine in the next lower gear or the next higher gear. It is therefore possible in a next step to check for each of the three gears (i.e. the next lower gear, the current gear and the next gear) whether any boundary conditions were infringed. They can be subsequent speeds, time-limited speed ranges of the internal combustion engine and the like. Every criterion which does not represent an absolute exclusion can be converted by means of a conversion factor into fuel consumption, as explained above. This is evidently the additional consumption that one needs to accept in order to fulfill the criterion, The transmission control is now able to calculate from these data the most advantageous gear with respect to total fuel consumption and to optionally shift to said gear by taking into account the additional fuel consumption for the shifting itself.

The invention will now be explained below in closer detail by reference to an embodiment, wherein:

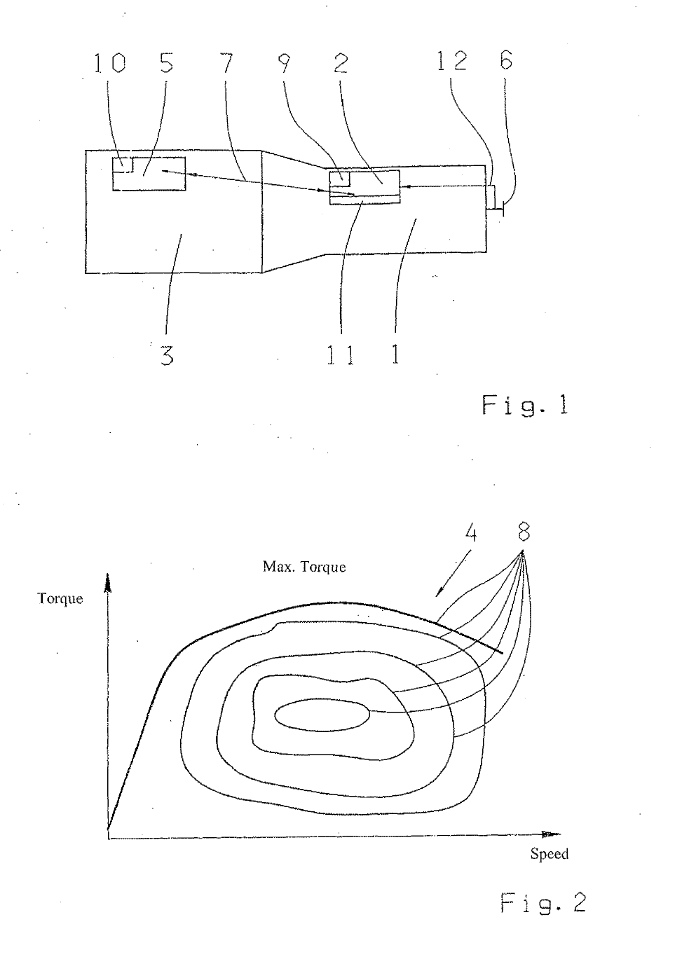

FIG. 1 shows a schematic view of a drive train with an internal combustion engine, an automatic transmission and a control device for the internal combustion engine and a transmission control device set up in accordance with the invention;

FIG. 2 also shows a schematic view of a characteristic map of the engine.

FIG. 1 shows an automatic transmission 1 which is connected on the output side to an internal combustion engine 3, which automatic transmission 1 comprises a transmission input shaft 13 and a transmission output shaft 6. The internal combustion engine 3 drives a transmission input shaft 13, which on its part drives the transmission output shaft 6, with a speed ratio between the transmission input shaft 13 and the transmission output shaft 6 which is determined by the gear engaged in the automatic transmission 1. The internal combustion engine 3 will be controlled by means of the engine control device 5, The automatic transmission 1 will be controlled by means of the transmission control device 2. The engine control device 5 and the transmission control device 2 are connected via a data bus 7, so that the transmission control device 2 is able to access a characteristic map 4 of the engine which is stored in the engine control unit 5 for the purpose of performing its control tasks, which characteristic map is shown by way of example in FIG. 2. The speed of the drive engine 3 is entered on the horizontal axis of the diagram and the torque generated by the internal combustion engine is entered on the vertical axis. Each combination of speed and torque is associated with specific fuel consumption. Lines of constant consumption are designated with reference numeral 8. Such a characteristic map 4 is also known as a contour curve diagram.

The upper bold line shows the maximum engine torque that can be output at a speed. With reference to FIG. 1, the transmission control device 2 comprises a data record 9 which contains an estimated value for the additional fuel consumption for each shifting which is caused by the shifting itself.

Reference numeral 11 relates to a computing device of the transmission control device 2. The computing device 11 is capable of determining whether or not it is worth performing a shifting concerning the most advantageous long-term fuel consumption of the internal combustion engine 3, which occurs on the basis of the characteristic map 4 of the engine in the characteristic map storage unit 10, which alternatively could also be stored in the transmission control device 2 after it was learned for example, and on the basis of the data record 9 with the estimated values for the additional fuel consumption during shifting. The shifting is performed in the automatic transmission 1 depending on this calculation. The transmission output speed and/or the speed of the transmission input shaft 13 can be used as a further input quantity for the computing device 11 or the transmission control device 2. The input of the transmission control device 2 for the transmission output speed is designated by way of example with reference numeral 12.

1-9. (canceled)

10. A method for controlling the gear shifting in an automatic transmission of a motor vehicle driven by an internal combustion engine, comprising:
predicting the fuel consumption of the internal combustion engine that would result if the automatic transmission were shifted from its present gear into a next higher gear with relatively low transmission ratio between a transmission input and a transmission output of the automatic transmission, and/or predicting the fuel consumption of the internal combustion engine that would result if the automatic transmission were shifted from its present gear into a next lower gear with a comparatively larger transmission ratio between the transmission input and the transmission output;
comparing the predicted fuel consumption of the internal combustion engine in the next higher gear of the automatic transmission and/or the predicted fuel consumption of the internal combustion engine in the next lower gear of the automatic transmission with the present fuel consumption of the internal combustion engine;
shifting the automatic transmission into the next higher gear or into the next lower gear depending on the comparison in order to obtain a reduction in fuel consumption;
wherein an additional fuel consumption resulting from the shifting process itself will be predicted before the shifting, and shifting is performed depending on said predicted additional fuel consumption.

11. The method according to claim 10, wherein an energetic amortization period is calculated from the predicted fuel consumption and the predicted additional fuel consumption by the shifting process itself, within which the predicted additional fuel consumption by shifting process itself would be saved during travel with the vehicle in the gear of the automatic transmission for which the fuel consumption was predicted, and shifting occurs depending on the energetic amortization period.

12. The method according to claim 11, wherein the shifting will only occur if the energetic amortization period lies beneath a predetermined limit value.

13. The method according to claim 10, wherein it is detected in operation of the motor vehicle how often the automatic transmission has shifted back within a predetermined interval to the gear prior to shifting within a predetermined distance recently travelled with the motor vehicle or within a predetermined, recently expired time interval after the shifting of the automatic transmission into the next higher or lower gear, that an average shift-down frequency can be determined therefrom, especially for various individual gears or for every single gear, with the exception of the highest gear and/or the lowest gear, and the shifting occurs depending on the average shift-down frequency.

14. The method according to claim 11, wherein it is detected in operation of the motor vehicle how often the automatic transmission has shifted back within a predetermined interval to the gear prior to shifting within a predetermined distance recently travelled with the motor vehicle or within a predetermined, recently expired time interval after the shifting of the automatic transmission into the next higher or lower gear, that an average shift-down frequency can be determined therefrom, especially for various individual gears or for every single gear, with the exception of the highest gear and/or the lowest gear, and the shifting occurs depending on the average shift-down frequency.

15. The method according to claim 12, wherein it is detected in operation of the motor vehicle how often the automatic transmission has shifted back within a predetermined interval to the gear prior to shifting within a predetermined distance recently travelled with the motor vehicle or within a predetermined, recently expired time interval after the shifting of the automatic transmission into the next higher or lower gear, that an average shift-down frequency can be determined therefrom, especially for various individual gears or for every single gear, with the exception of the highest gear and/or the lowest gear, and the shifting occurs depending on the average shift-down frequency.

16. The method according to claim 10, wherein the average shift-down period is detected in operation of the motor vehicle for a distance recently travelled with the motor vehicle or for a predetermined, recently expired time interval after which the automatic transmission, after shifting to a next higher gear or a next lower gear, was shifted back again to the gear before shifting, especially for individual gears, advantageously for every single gear with the exception of the highest and/or lowest gear, and that shifting occurs depending on the average shift-down period.

17. The method according to claim 11, wherein the average shift-down period is detected in operation of the motor vehicle for a distance recently travelled with the motor vehicle or for a predetermined, recently expired time interval after which the automatic transmission, after shifting to a next higher gear or a next lower gear, was shifted back again to the gear before shifting, especially for individual gears, advantageously for every single gear with the exception of the highest and/or lowest gear, and that shifting occurs depending on the average shift-down period.

18. The method according to claim 12, wherein the average shift-down period is detected in operation of the motor vehicle for a distance recently travelled with the motor vehicle or for a predetermined, recently expired time interval after which the automatic transmission, after shifting to a next higher gear or a next lower gear, was shifted back again to the gear before shifting, especially for individual gears, advantageously for every single gear with the exception of the highest and/or lowest gear, and that shifting occurs depending on the average shift-down period.

19. The method according to claim 13, wherein the additional fuel consumption will be predicted for the downshifting and is weighted with the average shift-down frequency and/or the average shift-down period, and the shifting occurs depending on the weighted additional fuel consumption for the downshifting.

20. The method according to claim 14, wherein the additional fuel consumption will be predicted for the downshifting and is weighted with the average shift-down frequency and/or the average shift-down period, and the shifting occurs depending on the weighted additional fuel consumption for the downshifting.

21. The method according to claim 15, wherein the additional fuel consumption will be predicted for the downshifting and is weighted with the average shift-down frequency and/or the average shift-down period, and the shifting occurs depending on the weighted additional fuel consumption for the downshifting.

22. The method according to claim 16, wherein the additional fuel consumption will be predicted for the downshifting and is weighted with the average shift-down frequency and/or the average shift-down period, and the shifting occurs depending on the weighted additional fuel consumption for the downshifting.

23. The method according to claim 17, wherein the additional fuel consumption will be predicted for the downshifting and is weighted with the average shift-down frequency and/or the average shift-down period, and the shifting occurs depending on the weighted additional fuel consumption for the downshifting.

24. The method according to claim 18, wherein the additional fuel consumption will be predicted for the downshifting and is weighted with the average shift-down frequency and/or the average shift-down period, and the shifting occurs depending on the weighted additional fuel consumption for the downshifting.

25. The method according to claim 10, wherein the shifting occurs depending on one or several of the following quantities which are predicted at least for the state after shifting and are detected or calculated especially for the current state prior to shifting for comparison:
ascending gradient on which the motor vehicle travels;
vehicle acceleration at current position of the driving pedal;
vehicle acceleration under full throttle;
engine speed;
vehicle speed;
connecting speeds of shifting elements in the automatic transmission;
time limitation of occurring speed ranges.

26. The method according to claim 25, wherein the quantities are converted into additional fuel consumption, especially by multiplication with a conversion factor which is predetermined for each quantity.

27. The transmission control device which controls the gear shifting in an automatic transmission, wherein the transmission control device is set up in such a way that it carries out the method according to claim 10.

28. The transmission control device which controls the gear shifting in an automatic transmission, wherein the transmission control device is set up in such a way that it carries out the method according to claim 11.

29. The transmission control device which controls the gear shifting in an automatic transmission, wherein the transmission control device is set up in such a way that it carries out the method according to claim 12.
